(19) United States
(12) Patent Application Publication
(10) Pub. No.: US 2004/0252209 A1
(43) Pub. Date: Dec. 16, 2004

(54) Digital programmable gain stage with high resolution for CMOS image sensors

(75) Inventor: Markus Loose, Thousand Oaks, CA (US)

Correspondence Address: Doyle B. Johnson, REED SMITH CROSBY HEAFEY LLP, P.O. Box 7936, San Francisco, CA, 94120-7936, US

(73) Assignee: Innovative Technology Licensing,LLC

(21) Appl. No.: 10/460,014

(22) Filed: Jun. 11, 2003

(51) Int. Cl. H04N 5/335

(52) U.S. Cl. 348/255

(57) ABSTRACT

A digital programmable gain stage for adjusting the gain of an input signal. A fine gain adjustment circuit sets gains between 1 and 2 (0-6 dB). A coarse gain adjustment stage adjusts the gain by multiples of 2. An input signal is multiplied by the fine gain adjustment factor, and then the coarse gain adjustment stage multiplies or divides the result by a multiple of 2. This architecture allows for gain adjustments from −24 dB to +66 dB in steps of 0.006 dB, using 14 bit resolution. Any number of gain ranges and gain resolutions are feasible with the current design by changing the bit width of the individual components.

### BACKGROUND OF THE INVENTION

1. Field of the Invention

The present invention relates generally to programmable gain stage circuits, and more particularly to a digital programmable gain stage with high resolution for CMOS image sensors.

2. Description of the Related Art

In modern camera applications utilizing electronic image sensors, there is a need to adjust the “gain” of the sensor in order to quickly adjust to different illumination levels. Gain refers to how much the picture signal from the sensor is amplified by in order to increase (or decrease) the input signal. Under low light conditions, the signal may need to be amplified by an order of magnitude or more. Similarly, under extremely bright conditions, the gain may need to be decreased by a large factor. This is especially true for video applications, where the illumination may vary over a wide range in a short period of time.

In order to achieve a smooth transition from one gain setting to another, a continuous analog-like adjustment of the effective gain is desired (i.e. automatic gain control). However, analog adjustable gain stages usually provide gain adjustment in large steps of 3 dB or 6 dB, which is produced by changing a capacitor or resistor ratio in the feedback of an operational amplifier. For image sensor applications, the desired adjustment steps would be more on the order of 0.01 to 0.001 dB. Another analog approach uses either a voltage or current input that continuously changes the gain within a certain range. The latter technique, however, requires complicated circuitry and makes it difficult to keep the gain constant for different operating conditions (temperature, supply voltage etc.)

Thus, there is a need for an improved programmable gain stage which realizes higher resolution adjustment of the gain, to allow for relatively smooth gain transition, without the use of complicated analog circuitry.

### SUMMARY OF THE INVENTION

In general, the present invention is a digital programmable gain stage for providing fine resolution gain adjustment, which is especially suited for video camera applications. In one embodiment, the present invention comprises a fine gain adjustment circuit that sets gains between 1 and 2 (0-6 dB). A coarse gain adjustment stage adjusts the gain by multiples of 2. An input signal is multiplied by the fine gain adjustment factor, and then the coarse gain adjustment stage multiplies or divides the result by a multiple of 2.

More specifically, the fine gain adjustment circuit may be implemented using either a look-up table or a processor (mulitplier). The coarse gain adjustment circuit may be implemented using a barrel shifter. A divider block may be added to convert a desired gain factor in decibels, into a linear scaling factor, by dividing the desired gain factor by 6. The integer portion of the division is used to determine how many places the barrel shifter shifts the result, and the remainder is used to calculated the fine gain adjustment factor according to the equation 10^{X/20}, where X is the remainder from the conversion division.

This architecture allows for gain adjustments from −24 dB to +66 dB in steps of 0.006 dB, using 14 bit resolution (upper 4 bits represent 6 dB steps, and low 10 bits represent 0.006 dB steps). This allows for smooth gain transitions, which is especially advantageous in video camera applications, where the light level may vary greatly in a short period of time. Any number of gain ranges and gain resolutions are feasible with the current design by changing the bit width of the individual components.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of a system utilizing the present invention; and

FIG. 2 is a block diagram of an embodiment of the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art, since the basic principles of the present invention have been defined herein specifically to provide a digital programmable gain stage with high resolution for CMOS image sensors. Any and all such modifications, equivalents and alternatives are intended to fall within the spirit and scope of the present invention.

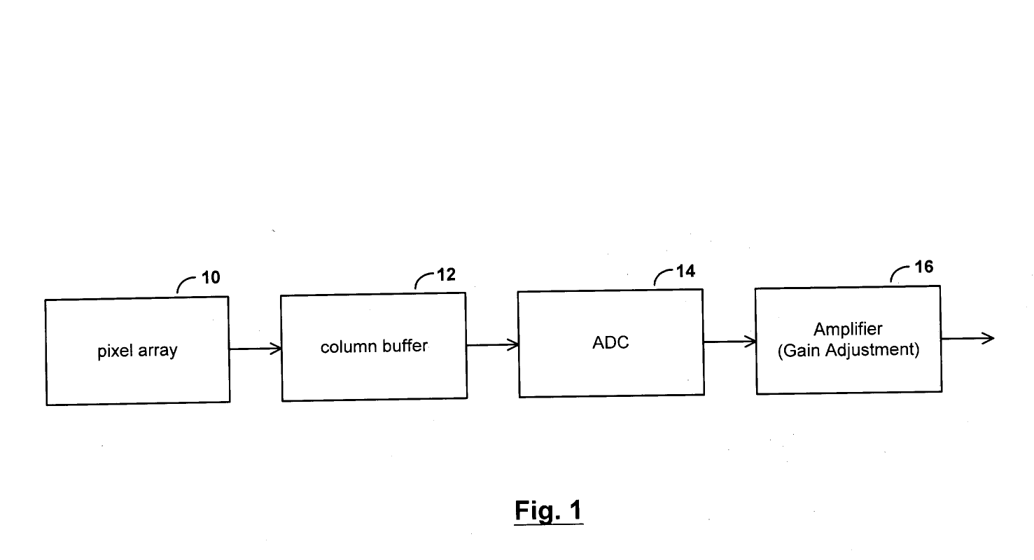

According to one embodiment of the present invention, as shown in FIG. 1, an output signal from each pixel in an image sensor 10 is output through a column buffer 12 and is then digitized using an ADC (analog-to-digital converter) 14. The gain of the output of the ADC 14 is then adjusted using the digital gain adjustment stage 16 of the present invention.

Two issues arise when attempting to adjust the gain of a pixel signal in the digital domain. First, the adjustment needs to be fine enough to provide for small variations in the gain setting. Additionally, gain is normally given in decibels (dB), which is logarithmic, and not in a linear scale. However, in order to more easily implement a multiplier, it is desirable that the gain factor be in a linear scale.

The present invention utilizes a completely digital approach to gain adjustment, while addressing the above concerns. The gain is achieved by multiplying the pixel value with a certain gain factor, where the gain factor is given by:

Output=Gain Factor*Pixel Value

Gain Factor=10^{Gain[dB]/20}

Gain[dB]=Coarse Gain+Fine Gain

where the Coarse Gain adjustment is in multiples of 6 dB (Gain Factors of 2, 4, 8, 16 . . . ), and where the Fine Gain is in adjustments of 0-6 dB. These equations show how to calculate a linear gain factor from a given gain represented in dB. Utilizing these equation, the present invention implements a gain adjustment stage which is capable of very fine gain adjustment.

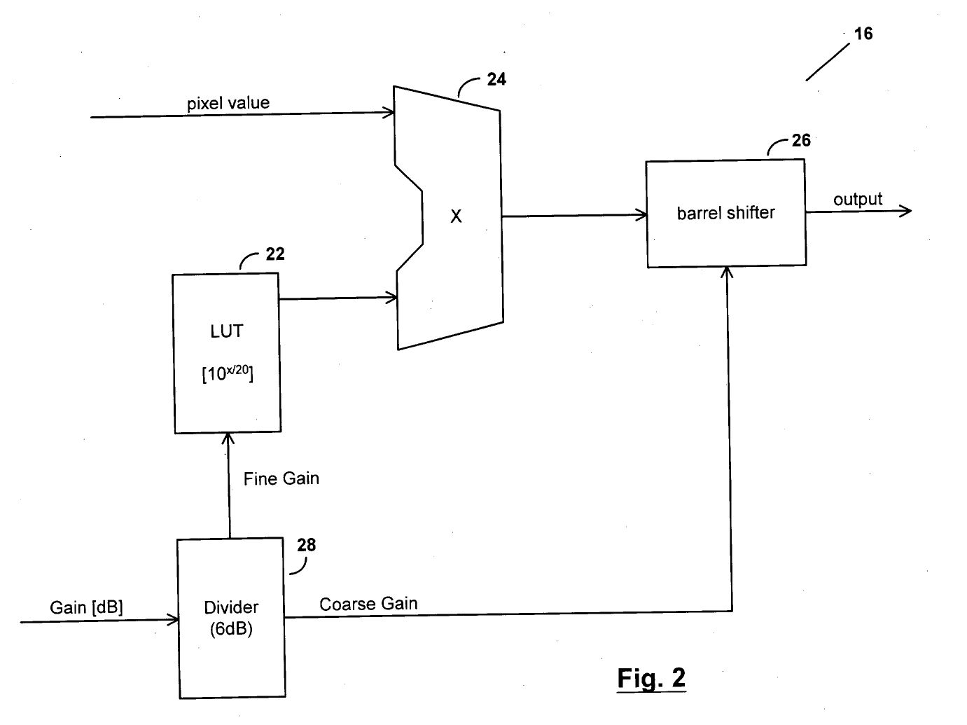

The digital gain adjustment scheme of one embodiment of the present invention is illustrated in FIG. 2. This architecture for a programmable fully digital gain stage 16 allows an accurate adjustment of the gain with a small step size over a large range. The two factors that are multiplied are the digital data value (pixel signal) and the gain factor (in dB). The gain factor can be directly programmed, or determined by applying an exponential function to a linear dB gain scale (by using a look-up table 22 which implements the logarithmic equation above, or an additional arithmetic unit).

The main components of this embodiment are a barrel shifter 26, a multiplier 24 and a look-up table 22 and a divider 28. The barrel shifter 26 is responsible for setting gains of 2, 4, 8, etc. (6 dB, 12 dB, 18 dB) by simply shifting the digital data by 1, 2, 3 or more bits to the left or to the right. Since the pixel value data is binary, a left shift corresponds to multiplying the data by 2, whereas a right shift corresponds to dividing the value by 2. The multiplier 24 is used to set an additional gain between 1 and 2 (0-6 dB) with an accuracy defined by the bit depth of the multiplier 24. Using 14 bit resolution, the present invention provides for gain adjustment from −24 dB to +66 dB in steps of 0.006 dB. Any number of gain ranges and gain resolutions are feasible with the current design by changing the bit width of the individual components.

The divider 28 may be implemented by either an arithmetic unit or a “splitter”, if the format of the gain values is chosen accordingly. In the alternate embodiment, a splitter utilizes some upper portion of a binary word as the Coarse Gain and the remaining lower bits as the Fine Gain. For example, in a 14 bit word, the upper 4 bits may represent the Coarse Gain, and the lower 10 bits represent the Fine Gain, as shown in the following table:

| Gain [dB] | 14 Bit Value |
|---|---|
| 0.006 | 1 |
| 0.012 | 2 |
| . | . |
| . | . |
| . | . |
| 3.01 | 512 |
| . | . |
| . | . |
| . | . |
| 6.02 | 1024 |
| 6.026 | 1025 |
| . | . |
| . | . |
| . | . |
| 12.04 | 2048 |
| . | . |
| . | . |
| . | . |

Thus, in this case dividing by 6 dB means dividing by 1024, which translates into shifting right by 10 bits. Thus, the splitter may be implemented using a barrel shifter to perform the division.

In operation, referring back to FIG. 2, consider an example where the desired gain of the digital gain stage 16 is 21 dB (or a linear multiplication factor of 11.2). First the 21 dB is divided by 6 in the divider 28, since 6 dB represents a doubling of the gain factor (i.e. multiplying a value by 2, or shifting a binary value one place to the left). This results in an integer portion of 3 and a remainder of 3. This integer portion is sometimes referred to as the “integer quotient”. As used herein, the term “integer portion” refers to the whole number result of the division process. The integer portion represents the Coarse Gain factor. Thus, the barrel shifter 26 will shift the output by 3 digits to the left, resulting in an effective linear multiplication by a factor of 8.

Prior to the shifting, however, the input pixel value is first multiplied by the Fine Gain factor. The remainder from the division is 3 dB, which represents the Fine Gain adjustment factor. As shown in FIG. 2, the pixel value is multiplied by the remainder, which is converted into a linear scale using a look-up table 22, or an arithmetic unit. In this example, placing a remainder of 3 into the look-up table would result in the pixel value being multiplied by 1.4. After the pixel value is multiplied by the Fine Gain factor, it is then multiplied by the Coarse Gain adjustment factor of 8, by shifting the output of the multiplier 24 by 3 places to the left in the barrel shifter 26. Thus, the input signal is multiplied by a total factor of 11.2 (1.4*8=11.2).

As described, the present invention is preferably implemented using a look-up table to convert the remainder from dB into a linear scale, although this calculation could be performed by a processor as well. Since the inputs are well defined, the look-up table can be created and stored, such that the values do not have to be calculated each time. The look-up table is preferred over a processor since it is faster, easier to implement, and utilizes less space and power than a processor for most applications.

Thus, the present technique provides for finer resolution gain adjustment than can be provided with analog approaches. For video imaging applications, this allows camera designers to provide for relatively smooth gain transitions as a camera pans from dark to light scenes, or light to dark scenes, while using less power and less space on chip than many analog approaches.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A digital programmable gain circuit for adjusting a gain of a digital input signal, the circuit comprising:
a multiplier having a first input and a second input, the digital input signal being connected to the first input;
a fine gain adjustment circuit having an output connected to the second input of the multiplier; and
a coarse gain adjustment circuit connected to an output of the multiplier.

2. The digital programmable gain circuit of claim 1, wherein the fine gain adjustment circuit determines a linear scale factor between 1 and 2.

3. The digital programmable gain circuit of claim 2, wherein the coarse adjustment circuit multiplies or divides the output of the multiplier by a multiple of 2.

4. The digital programmable gain circuit of claim 3, further comprising a divider circuit connected to the fine gain adjustment circuit and the coarse gain adjustment circuit, wherein the divider circuit divides a gain value in decibels by 6, and outputs an integer portion of a result to the coarse gain adjustment circuit, and a remainder portion of the result to the fine gain adjustment circuit.

5. The digital programmable gain circuit of claim 4, wherein the fine gain adjustment circuit is a look-up table containing pre-calculated values for an input X, where the values are determined by an equation 10^{X/20}.

6. The digital programmable gain circuit of claim 5, wherein the coarse gain adjustment circuit is a barrel shifter.

7. The digital programmable gain circuit of claim 4, wherein the fine gain adjustment circuit is an arithmetic calculation unit.

8. The digital programmable gain circuit of claim 4, wherein the divider circuit comprises a splitter, which utilizes an upper portion of the gain value as a coarse gain adjustment, and a lower portion of the binary word as the fine gain adjustment.

9. A digital programmable gain circuit for adjusting a gain of an input pixel signal, the circuit comprising:
a multiplier having a first input and a second input, the first input connected to the pixel signal;
a fine gain adjustment circuit connected to the second input of the multiplier, the fine gain adjustment circuit comprising a look-up table with pre-calculated conversion values corresponding to a conversion equation 10^{X/20}, where X is an input value; and
a coarse gain adjustment circuit connected to an output of the multiplier, the coarse gain adjustment circuit comprising a barrel shifter for multiplying or dividing a value of a multiple of 2;
wherein the input pixel value is first multiplied by an output of the fine gain adjustment circuit, and then an output of the multiplier is shifted either left or right by the barrel shifter.

10. The digital programmable gain circuit of claim 9, further comprising a divider circuit connected to the fine gain adjustment circuit and the coarse gain adjustment circuit, wherein the divider circuit divides a gain value in decibels by 6, and outputs an integer portion of a result to the coarse gain adjustment circuit, and a remainder portion of the result to the fine gain adjustment circuit.

11. The digital programmable gain circuit of claim 10, wherein the divider circuit comprises a splitter, which utilizes an upper portion of the gain value as a coarse gain adjustment, and a lower portion of the binary word as the fine gain adjustment.

12. A method for adjusting the gain of an input signal, the method comprising:
digitizing the input signal;
inputting the digitized input signal into a multiplier;
converting a desired gain factor in decibels into a linear scale by dividing the desired gain factor by 6;
converting a remainder portion of the division step into a fine gain adjustment factor;
multiplying the digitized input signal by the fine gain adjustment factor; and
shifting an output of the multiplier either left or right, based on a result of the division step.

13. The method of claim 12, wherein the step of converting a remainder portion of the division step into a fine gain adjustment factor comprises inputting the remainder into a look-up table having pre-calculated conversion values according to the equation: 10^{X/20}, where X is the remainder.

14. A digital camera system comprising:
an array of pixel elements;
a column buffer connected to the array, the column buffer reading an output signal from each pixel;
an analog-to-digital converter connected to the column buffer, the analog-to-digital converter converting each output signal into a digital signal; and
a programmable digital gain stage connected to the analog-to-digital converter, the programmable digital gain stage comprising:
a multiplier having a first input and a second input, the first input connected to the pixel signal;
a fine gain adjustment circuit connected to the second input of the multiplier, the fine gain adjustment circuit comprising a look-up table with pre-calculated conversion values corresponding to a conversion equation 10^{X/20}, where X is an input value; and
a coarse gain adjustment circuit connected to an output of the multiplier, the coarse gain adjustment circuit comprising a barrel shifter for multiplying or dividing a value of a multiple of 2;
wherein the input pixel value is first multiplied by an output of the fine gain adjustment circuit, and then an output of the multiplier is shifted either left or right by the barrel shifter.

15. The digital camera system of claim 14, further comprising a divider circuit connected to the fine gain adjustment circuit and the coarse gain adjustment circuit, wherein the divider circuit divides a gain value in decibels by 6, and outputs an integer portion of a result to the coarse gain adjustment circuit, and a remainder portion of the result to the fine gain adjustment circuit.

16. The digital camera system of claim 15, wherein the divider circuit comprises a splitter, which utilizes an upper portion of the gain value as a coarse gain adjustment, and a lower portion of the binary word as the fine gain adjustment.

17. The digital camera system of claim 15, wherein the fine gain adjustment circuit comprises a mathematical processor, instead of a look-up table.
